(19) United States
(12) Patent Application Publication
(10) Pub. No.: US 2021/0082029 A1
(43) Pub. Date: Mar. 18, 2021

(54) Intermediary Method, Intermediary Device, and Recording Medium/Program

(71) Applicant: beepnow, inc., Wilmington, DE (US)

(72) Inventor: Alex Tsai, Osaka-shi, Osaka (JP)

(21) Appl. No.: 16/963,707

(22) PCT Filed: Jan. 24, 2019
(86) PCT No.: PCT/IB2019/050584

§ 371 Date: Jul. 21, 2020

(30) Foreign Application Priority Data
Jan. 25, 2018 (JP) 2018-010824

(51) Int. Cl. G06Q 30/06; G06Q 10/08; G06Q 30/08

(52) U.S. Cl. CPC G06Q 30/0633; G06Q 30/08; G06Q 10/0838

(57) ABSTRACT

Provides brokerage methods, brokerage equipment and computer programs. An intermediary method for intermediary transactions of goods or services between an orderer and an orderer by using a computer communicatively connected to the orderer's terminal and the orderer's terminal, wherein information on the goods or services to be ordered is sent to the orderer's terminal, the selection of the goods or services to be ordered is accepted through the orderer's terminal, and settlement is processed for the receipt and ordering of the selected goods or services. The evaluation of the orderer by the orderer who placed the goods or services and the evaluation of the orderer by the orderer are received from both the orderer's terminal and the orderer's terminal, and the computer executes processing to store the received evaluations of the orderer and the orderer in a distributed ledger.

### CROSS-REFERENCE TO RELATED APPLICATIONS

This application is the national phase of PCT International Application No. PCT/IB2019/050584 which has an International filing date of Jan. 24, 2019 and designated the United States of America.

### FIELD

The present invention relates to an intermediary method, an intermediary device, and a recording medium/program. This application claims priority based on the Japanese application No. 2018-010824 of 25 Jan. 2018 and incorporates all the contents of the preceding Japanese application.

### BACKGROUND

In recent years, electronic commerce (e-commerce), in which goods are sold over communication networks like internet, has become widely used (see, for example, Japanese Patent Laid-open No. 2002-63132).

When a user buys a product using such e-commerce, it is often based on the evaluations of other users who have purchased the product.

### SUMMARY

Since user evaluations and ratings information is stored on server equipment and installed by distributors, there is a risk that evaluations may be changed falsely or corrupted by the server equipment administrators, etc.

The purpose of this invention is to provide a transaction intermediary method, a brokerage intermediary device, and a recording medium/program that can prevent a user's evaluation and rating from being tampered with by orderer.

The intermediary method pertains to one aspect of the present invention. This is for transaction of goods or services between the orderer receiver using communication network connections and the orderer; wherein the information about the goods or services to be ordered is transmitted to the orderer's terminal, the selection of the goods or services to be ordered is approved through the orderer's terminal, and the settlement process for receiving and ordering the selected goods or services is performed, the evaluation of the order receiver by the orderer who ordered the goods or services and the evaluation of the orderer by the order receiver are received from both the orderer's terminal and the order receiver's terminal, and the evaluation of the orderer and the order receiver is stored in a distributed ledger by the computers.

An intermediary device according to one aspect of the present invention. This mediates communication connections between an orderer receiver terminal and the orderer's terminal; this includes a transmitting part that transmits information on goods or services to an orderer's terminal, a receiving part that accepts the selection of goods or services through the orderer's terminal, a settlement processing part that processes settlement for receiving and ordering selected goods or services, and a receiving part that receives the evaluation or rating information of the orderer receiver by the orderer who placed the said goods or services including the evaluation of the orderer by the order receiver from both the order receiver's terminal and the orderer's terminal, and a memory processing part that stores the received evaluations of the orderer receiver and the orderer in a distributed ledger.

Pertaining to one aspect of the present invention, is a recording medium/program that stores a computer program for executing the process of obtaining information on goods or services to be ordered from an intermediary device that mediates transactions of goods or services between an order receiver and an orderer; accepting a selection of goods or services to be ordered from among the said goods or services, sending information on the goods or services selected for ordering the selected goods or services to the said intermediary device, accepting an evaluation of an order receiver after ordering the said goods or services, and sending the said evaluation to store the received evaluation in a distributed ledger.

A recording medium/program pertaining to the present invention stores a computer program for executing a process of receiving information; on goods or services to be ordered selected by an orderer from an intermediary device that mediates transactions of goods or services between an orderer and an order receiver, receiving an evaluation of the orderer and transmitting the evaluation to store the evaluation in a distributed ledger after receiving an order for the said goods or services.

According to the present invention, the evaluation or rating information by orderers and order receivers is prevented from being be changed falsely or corrupted by other people.

The above and further objects and features of the invention will more fully be apparent from the following detailed description with accompanying drawings.

### BRIEF DESCRIPTION OF DRAWINGS

FIG. 1 is a schematic diagram showing an example of the transaction intermediary system in this embodiment;

FIG. 2 is a block diagram explaining the internal structure of the intermediary device;

FIG. 3 is a block diagram explaining the internal configuration of the order receiver's terminal;

FIG. 4 is a block diagram of the internal configuration of the orderer's terminal;

FIG. 5 is an explanatory diagram explaining the registration contents of the user database provided by an intermediary device;

FIG. 6 is an explanatory diagram explaining the contents of the order contents registration database provided by an intermediary device;

FIG. 7 is a schematic diagram showing an example of the order receiver's search screen displayed on the orderer's terminal;

FIG. 8 is a schematic diagram showing an example of the order details display screen;

FIG. 9 is a schematic diagram showing an example of an order screen displayed on the display part of the order receiver's terminal;

FIG. 10 is a schematic diagram showing an example of a payment screen displayed on the orderer's terminal;

FIG. 11 is a schematic diagram showing an example of the evaluation screen displayed on the orderer's terminal;

FIG. 12 is a schematic diagram showing an example of the evaluation screen displayed on the display part of the order receiver's terminal;

FIG. 13 is an explanation of a blockchain registration;

FIG. 14 is a flowchart explaining the processing procedures executed by the intermediary device, the order taker's terminal, and the order's terminal;

FIG. 15 is an schematic diagram showing an example of the order receiver search screen of embodiment 2;

FIG. 16 is an schematic diagram showing an example of an orderer search screen pertaining to embodiment 2;

FIG. 17 is a schematic diagram showing an example of a setting screen for setting the receipt of compensation;

FIG. 18 is a schematic diagram showing an example of the borrowing application screen;

FIG. 19 is a schematic diagram showing an example of the approval confirmation screen;

FIG. 20 is a flowchart explaining the processing procedure of user authentication executed by the intermediary device pertaining to embodiment 5;

FIG. 21 is a block diagram explaining the internal structure of the dispatcher terminal used by the dispatcher;

FIG. 22 is a flowchart explaining the processing procedures executed by the intermediary device pertaining to embodiment 6;

FIG. 23 is a schematic diagram showing an example of an order screen displayed on the display part of the order receiver's terminal;

FIG. 24 is a flowchart explaining the processing procedures executed by the intermediary device pertaining to embodiment 7;

FIG. 25 is a schematic diagram showing an example of the order receipt screen displayed on the display part of the order receiver's terminal in embodiment 8; and

FIG. 26 is a schematic diagram showing an example of a settlement screen displayed on the display part of an orderer's terminal in embodiment 8.

### DESCRIPTION OF EMBODIMENTS

In the following, the present invention is explained in detail based on the drawings showing the system of operation.

### Embodiment 1

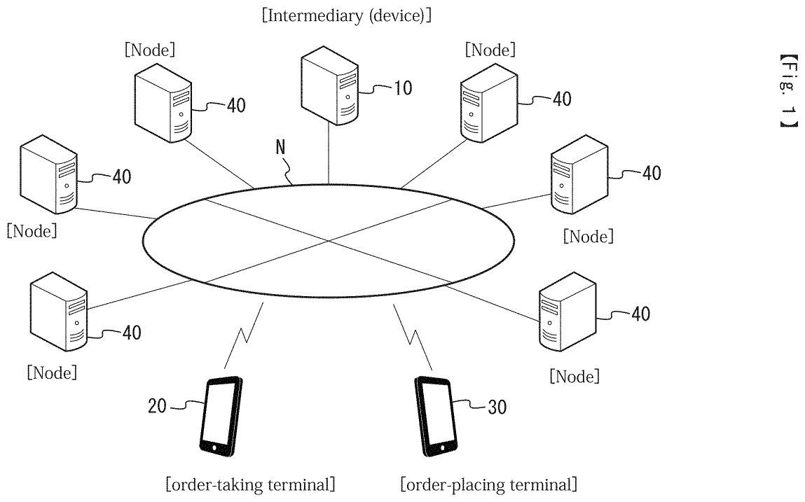

FIG. 1 is a schematic diagram showing an example of the composition of the transaction intermediary system of the present embodiment form. The transaction intermediary system of this embodiment includes an intermediary device 10 for intermediary transactions between an order receiver and an orderer, an order receiver terminal 20 for use by an order receiver, an orderer terminal 30 for use by an orderer, and a plurality of nodes 40, 40, . . . , 40 that share a distributed ledger. The intermediary device 10, the order taker terminal 20, the order taker terminal 30, and each node 40 are connected to a peer-to-peer (P2P) network N, for example, and are configured to communicate with each other. One of the features of the transaction intermediary system of the present embodiment is that the transaction of goods or services (receiving/ordering) between an orderer and an order receiver is mediated by an intermediary device 10, and the evaluation of the order receiver by the orderer and evaluation of the orderer by the order receiver are obtained from the ordering receiver's terminal 20 and the orderer's terminal 30, respectively, and the information of the obtained evaluation is stored in a distributed ledger.

Note in FIG. 1, the orderer-taker's terminal 20 and the orderer's terminal 30 are described one by one, but the orderer-taker's terminal 20 and the orderer's terminal 30 may be configured to have multiple terminals each. In this embodiment, the intermediary device 10, the order receiver terminal 20, the orderer's terminal 30, and each node 40 are connected to a peer-to-peer network N. The intermediary device 10, the order receiver terminal 20, and the order-placing terminal 30 are connected to another network, such as an Internet network, and the intermediary device 10 and with the plurality of nodes 40, 40, . . . , 40 may be connected to the above network N where the distributed ledger is shared by the intermediary device 10 and the plurality of nodes 40, 40, . . . , 40.

In the transaction intermediary system of the present embodiment, an order receiver registers information on goods or services that he or she can accept orders with the intermediary device 10. For example, the order receiver registers information about the product, including the product for sale and the price of the product, with the intermediary device 10. In addition, the order taker may register service information, including service contents and service prices, with respect to the service that can be provided, with the intermediary device 10. The services that an orderer registers in the intermediary device 10 are optional; and may register his or her own labor as a service, or may register the lending of various equipment, vehicles, facilities, places, and the like as a service.

The intermediary device 10 transmits information on the goods or services registered by the order receiver to the orderer's terminal 30 in response to access from the orderer's terminal 30. The orderer selects the goods or services to be ordered from the information of the goods or services displayed on the orderer's terminal 30. The information on the goods or services selected by the orderer is communicated to the intermediary device 10 through the orderer terminal 30.

The intermediary device 10 mediates a transaction related to the goods or services to be ordered, which is selected at the orderer's terminal 30 (order-receive processing). Specifically, the intermediary mediates transactions between an order receiver and an orderer by requesting a deposit of virtual currency in an amount equal to the value of goods or services ordered by the orderer plus a commission (system usage fee), and remitting the virtual currency to a wallet designated by the orderer by subtracting the commission for the order receiver and the commission (system usage fee) from the deposit amount in response to request processing.

Upon completion of the transaction between the orderer and the order receiver, the orderer will be able to enjoy the goods or services provided by the order receiver. After enjoying the goods or services provided by the order receiver, the orderer shall make an evaluation of the orderer. The evaluation of the order receiver by the orderer is transmitted to the intermediary device 10 through the orderer's terminal 30. In addition, the contractor shall conduct an evaluation of the orderer. The evaluation of the orderer by the order receiver is transmitted to the intermediary device through the order receiver's terminal 20.

The intermediary device 10 stores the evaluation of the order receiver received through the orderer's terminal 30 and the evaluation of the orderer received through the order receiver's terminal 20 in a distributed ledger shared by the nodes 40 on the network. An example of a distributed ledger is a blockchain, which makes tampering difficult by having multiple nodes 40, 40, . . . , 40 connected to the network store the same contents. In this embodiment, a highly reliable and fair platform is provided by using a blockchain that has a data structure that is easy to detect tampering by using an electronic signature and a hash pointer, and that achieves high availability and data identity by having the data in question be held by nodes distributed over network N.

In the following explanations, if it is not necessary to distinguish between an order receiver and an orderer, the term “user” shall also be used simply. A user of the order receiver terminal 20 may place an order for goods or services using the order receiver's terminal 20, and a user of the orderer's terminal 30 may use the orderer's terminal 30 to register the goods or services to be ordered with the intermediary device 10. In other words, in the present embodiment, the distinction between the order receiver's terminal 20 and the orderer's terminal 30 is only for convenience, and the order receiver's terminal 20 and the order receiver's terminal need not be a terminal for ordering or a terminal for placing orders, respectively.

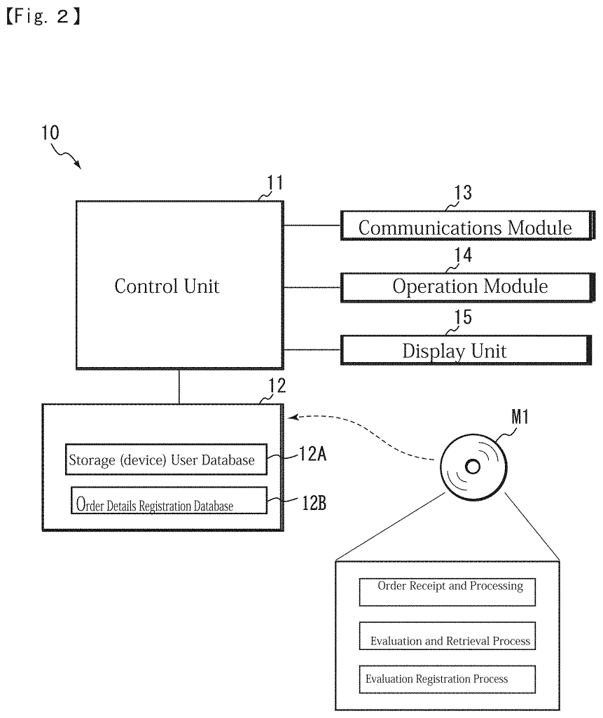

FIG. 2 is a block diagram explaining the internal configuration of the intermediary device 10. The intermediary device 10 includes, for example, a control unit 11, a storage unit 12, a communication unit 13, an operation unit 14, and a display unit 15.

The control unit 11 is equipped with a CPU (Central Processing Unit), a ROM (Read Only Memory), a RAM (Random Access Memory), etc., for example. The CPU of the controller 11 controls the operation of the above-mentioned hardware by developing and executing various programs stored in advance in the ROM or the memory 12 in the RAM, and makes the entire device function as the intermediary device (computer) of this application.

The control unit 11 is not limited to the above configuration, but may be any processing circuit including one or more CPUs, multi-core CPUs, microcomputers, etc. Also, the control unit 11 may have functions such as a clock to output date and time information, a timer to measure the elapsed time from the start of measurement to the end of measurement, a counter to count the number, and the like.

The storage unit 12 is equipped with a storage device using SRAM (Static Random Access Memory), flash memory, hard disk, and the like. Various computer programs executed by the control unit 11 and the data necessary for executing the computer programs are stored in the storage unit 12. The computer program stored in the memory portion 12 includes an operating system, which is a program for controlling the entire operation of the intermediary device 10, and an ordering and receiving program for a process of brokering transactions between an orderer and an order receiver.

The program stored in the memory part 12 may be provided by a non-transient recording medium M1 that records the program in a readable format. The recording medium M1 is a portable memory, such as a CD-ROM, USB memory, SD (Secure Digital) card, micro SD card, compact flash (registered trademark), etc. In this case, the control unit 11 reads various programs from the recording medium M1 using a reading device (not shown) and installs the programs in the memory unit 12. In addition, the program stored in the storage portion 12 may communicate via the communication unit 13. In this case, the control unit 11 acquires various programs through the communication unit 13 and installs the acquired programs in the memory unit 12.

The storage portion 12 may also include a user database 12A for storing user information and an order content registration database 12B for storing information on goods or services registered by an order receiver.

The communication part 13 has a connection interface for connecting to the network N. The communication part 13 has a connection interface for connecting to the network N. When the communication part 13 receives information transmitted from the order receiver's terminal 20, the orderer's terminal 30, etc. through the network N, it outputs the received information to the control part 11. When the communication part 13 obtains information from the control part 11 that should be sent to the order receiver's terminal 20, the orderer's terminal 30, etc., the communication part 13 sends it to the order receiver's terminal 20, the orderer's terminal 30, etc., through network N.

The actuator 14 is equipped with an input interface such as a keyboard and a mouse to accept operations by an administrator of the intermediary device 10, etc. The display unit 15 is equipped with a liquid crystal display device, etc., and displays information that should be reported to the manager of the intermediary device 10, etc. The display unit 15 is equipped with a liquid crystal display device, etc., and displays information that should be reported to the manager of the intermediary device 10, etc. In this embodiment, the intermediary device 10 is configured to have an operation portion 14 and a display portion 15, but the operation portion 14 and the display portion 15 are not required, and the intermediary device 10 may be configured to accept operations through an externally connected computer and output the information to be notified to an external computer.

Note that in the present embodiment, the intermediary device 10 is described as a single device for simplicity but may be configured with a plurality of processing devices or may be configured with one or multiple virtual machines.

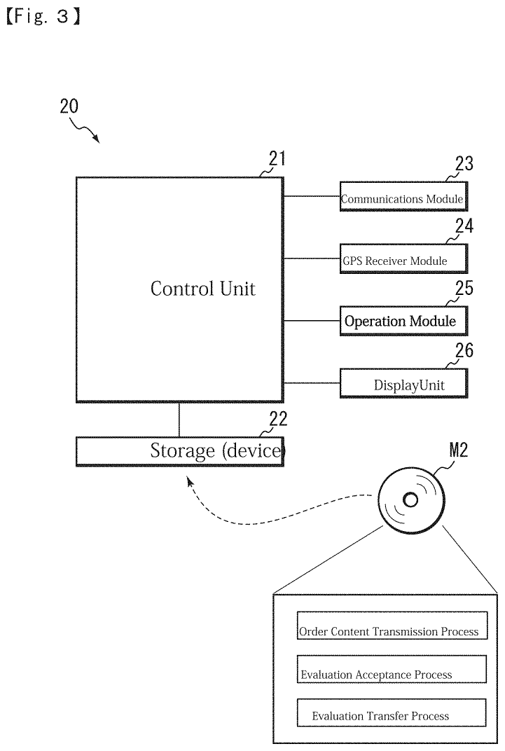

FIG. 3 is a block diagram explaining the internal configuration of the order-taking terminal 20. The order receiver's terminal 20 is a terminal device, such as a smartphone or a personal computer, and is equipped with a control unit 21, a storage unit 22, a communication unit 23, a GPS (Global Positioning System) receiver 24, an operation unit 25, and a display unit 26.

The control unit 21 is equipped with a CPU, a ROM, a RAM, etc. The ROM of the controller 21 stores control programs, etc., to control the operation of the above hardware parts. The CPU in the controller 21 executes the control programs stored in the ROM and the various programs stored in the memory 22 to be described later to control the operation of the above hardware parts. The RAM provided by the control unit 21 stores data that is temporarily used during the execution of various programs.

The control unit 21 is not limited to the above configuration, but may be one or more processing circuits including a single-core CPU, a multi-core CPU, a microcomputer, volatile or non-volatile memory, etc. In addition, the control portion 21 may have functions such as a clock to output date and time information, a timer to measure the elapsed time from providing an indication to start measurement to providing an indication to end measurement, a counter to count the number, and the like.

The storage unit 22 contains a storage device using SRAM, flash memory, hard disk, etc. In the memory part 22, the operating system executed by the control part 21, a program that provides an application for the orderer in the transaction intermediary system pertaining to this embodiment, and various data used in the program, etc. are stored.

The program stored in the memory part 22 may be provided by the recording medium M2, which is a readable record of the program in question. The recording medium M2 is a portable memory such as CD-ROM, USB memory, SD card, micro SD card, compact flash (registered trademark), etc. In this case, the control unit 21 reads the various programs from the recording medium M2 using the reading device not shown and installs the programs in the memory unit 22. The program stored in the storage portion 22 may also be provided by communication via the communication portion 23. In this case, the control part 21 acquires various programs through the communication part 23 and installs the acquired programs in the memory part 22.

The communication part 23 is equipped with a communication interface to connect to the network N and sends various information to be notified to the outside and receives various information to be sent from the outside.

The GPS receiver 24 receives radio waves transmitted from the GPS satellite (not shown) and positions the current position of the order receiver's terminal 20, and the GPS receiver 24 outputs the position information of the current position of the order receiver's terminal 20 to the control unit 21.

The operation part 25 is equipped with an input interface such as a touch panel and an operation button and receives various operation information and setting information. The control unit 21 performs appropriate control based on the operation information input from the operation unit 25, and stores setting information in the memory unit 22 as needed.

The display unit 26 is equipped with a display device such as a liquid crystal display panel, an organic EL display panel, etc., and displays information to be notified to the orderer based on control signals output from the control unit 21.

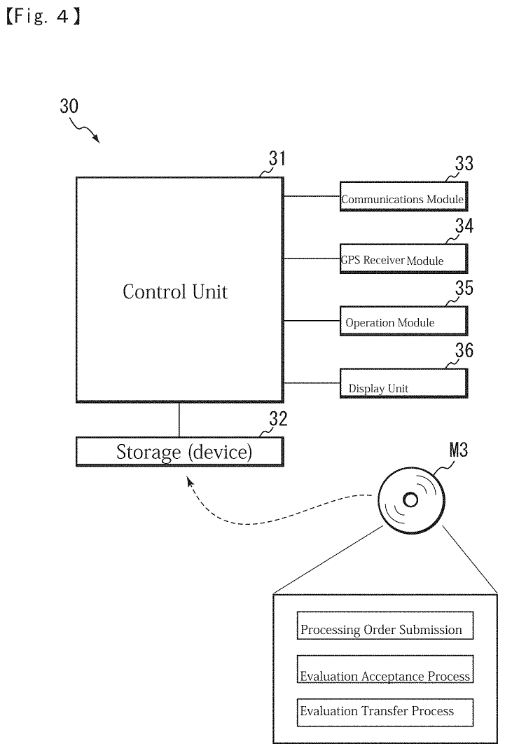

FIG. 4 is a block diagram explaining the internal configuration of the orderer's terminal 30. The orderer's terminal 30 is a terminal device, such as a smartphone or a personal computer, and includes a control unit 31, a memory unit 32, a communication unit 33, a GPS receiver 34, an operation unit 35, a display unit 36, and the like.

The operation of the above hardware in the ordering terminal 30 is the same as the operation of the hardware in the ordering terminal 20, so this explanation is omitted. The program stored in the memory part 32 of the orderer's terminal 30 includes a program that provides an application for the orderer in the transaction intermediary system of this embodiment form, and may be provided by a readable recording medium M3 that contains the said program. Moreover, in the present embodiment, the order receiver's terminal 20 and the orderer's terminal 30 are described only for convenience and distinction, and both programs that provide applications for the orderer and programs that provide applications for the orderer, or programs that integrate them, may be installed on the order receiver's terminal 20 and the orderer's terminal 30.

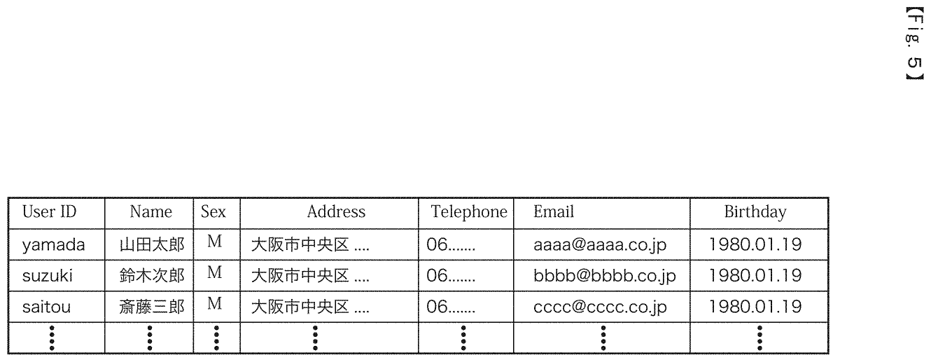

FIG. 5 is an explanatory diagram explaining the registration contents of the user database 12A provided by the intermediary device 10. The user database 12A stores the user's personal information such as name, gender, address, telephone number, e-mail address, and date of birth of the user (orderer or order receiver) in relation to the user ID. Here, the user ID is a unique identifier that identifies each user in the system and can be the name of the order taker or an arbitrary code. Each user uses the user ID and password assigned to him/her to access the intermediary device 10 and register the above-mentioned personal information in the user database 12A. The information registered in the user database 12A is not limited to the above but may also include information on the distinction between an orderer and an ordering receiver and information showing the attributes of each user.

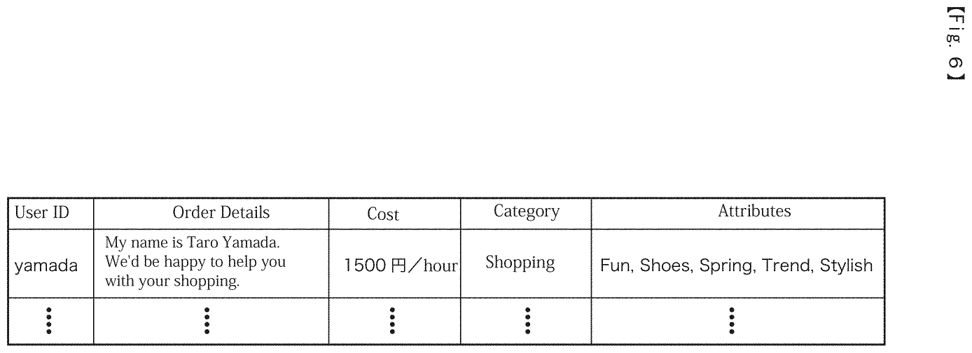

FIG. 6 is an explanation of the contents of the order contents registration database 12B provided by the intermediary device 10. Order details registration database 12B stores information such as user ID, order details, type of order details, and order price in relation to the order. Each order taker accesses the intermediary device 10 from the order taker's terminal 20 using the user ID and password set for each user, and registers the order details, order price, order type (category), attributes of the order taker, and other information in the order details registration database 12B.

The content of the order is the information that represents the content of the goods or services to be provided by the order receiver. The order price is the consideration for the goods or services to be provided by the order receiver and may be set arbitrarily by the orderer. The order price may be a price per unit period, such as per hour or per day, or it may be a price that does not depend on the period. The type of order is the category to which the goods or services to be ordered belong. The attributes of an orderer are registered with keywords that indicate the characteristics of the orderer.

Note that the contents of the order contents registration database 12B are not limited to the above. For example, the order content registration database 12B may include information on the time-period, day of the week, etc. during which the orderee can provide the goods or services. In addition, the order content registration database 12B may include information on areas where the order taker can provide goods or services.

In addition, the registration period for each order may be set for each order content in the order content registration database 12B. If the registered order content has a registration period, and the registration period has passed, the intermediary device 10 deletes the registered content from the order content registration database 12B after the registration period has passed.

In the present embodiment, we will explain that the intermediary device 10 is equipped with a user database 12A and an order content registration database 12B, but these databases may be configured to be connected to the outside of the intermediary device 10. In this case, the intermediary device 10 may be able to access each database through the communication part 13 or the input/output interface not shown in the figure.

The operation of the transaction intermediary system of this embodiment is described below, referring to the display screen displayed on the display part 26 of the order receiver's terminal 20 and the display part 36 of the orderer's terminal 30.

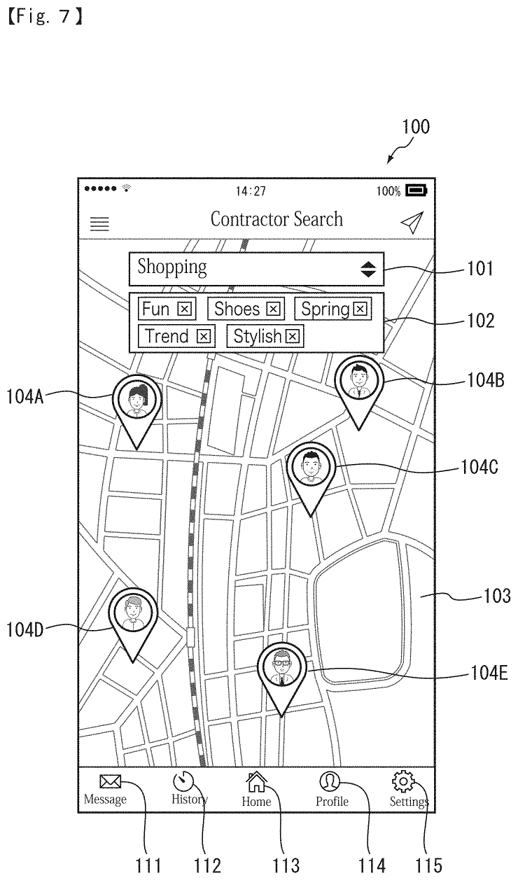

FIG. 7 is a schematic diagram showing an example of the orderer search screen 100 displayed on the display portion 36 of the orderer terminal 30. When an orderer uses the trade brokerage system of this embodiment to place an order of any kind, the orderer enters the user ID and password assigned to him/her into the orderer's terminal 30 and accesses the brokerage device 10 through the orderer's terminal 30. The orderer terminal 30 obtains data for the display screen from the intermediary device 10 and displays the orderer search screen 100 on the display portion 36.

For example, the orderee search screen 100 includes a category selection column 101 for selecting a category of order content, an attribute setting column 102 for setting attributes required by the orderee, and a display column 103 for displaying the search results. In addition, at the bottom of the orderer search screen 100, there are message buttons 111 that move to the screen where messages are exchanged between the orderer and the orderer and between the orderer and the system, history buttons 112 that move to the transaction history screen, home buttons 113 that move to the home screen, profile buttons 114 that move to the user's profile screen, and setting buttons 115 that move to the setting screen for accepting various settings.

If the orderer terminal 30 accepts the selection of a category of order contents and the attributes of the orderer through the orderer search screen 100 displayed on the display portion 36, it requests the intermediary device 10 to search for an appropriate orderer. It is not necessary to set the attributes of the orderer at the time of the search request but may be configured to accept the selection of a category and make a search request based on the selected category.

If the intermediary device 10 receives a search request from the order taker's terminal 30, it searches for the relevant order taker from the order content registration database 12B and sends the information on the order taker that matches the search conditions to the order taker's terminal 30. At this time, the intermediary device 10 may obtain location information from the order receiver's terminal 20, which is used by the order receiver, and transmit the obtained location information (i.e., location information of the order receiver) to the orderer's terminal 30.

When the orderer terminal 30 receives a search result from the intermediary device 10, the information of the orderer is displayed in the display column. If the search result includes location information of the orderer, the orderer's terminal 30 may display the information of the orderer superimposed on the map image. Note that the orderer's terminal 30 may obtain map data from an external server to superimpose and display the orderer's information on the map image.

FIG. 7 shows an example of the search results when “Shopping” is selected as the order category and attributes such as “Fun”, “Shoes”, “Spring”, “Trend”, and “Stylish” are selected. In FIG. 7, an orderer matching the search conditions (categories and attributes) is indicated by icons 104A to 104E, which indicate their position on the map. When a selection operation (e.g., a touch operation on the display screen) to select any one of the icons 104A to 104E to indicate the position of the orderer is accepted, the orderer's terminal 30 displays information about the order received by the selected orderer on the display portion 36.

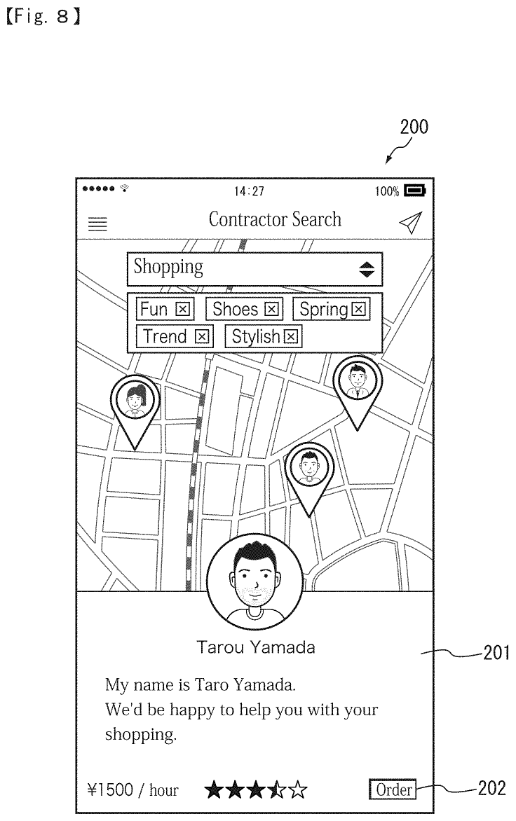

FIG. 8 is a schematic diagram showing an example of the order content display screen 200. The order contents display screen 200 shown in FIG. 8 is a screen that is displayed on the display part 36 of the orderer terminal 30 when the selection operation for the icon 104C, for example, is accepted on the orderer search screen 100 described above. The order content display screen 200 has a display column 201 for displaying information about the person who received the order and the order content, and an order button 202 for giving order instructions. In the order information display screen 200 shown in FIG. 8, the display column 2100 shows that the order was placed by Taro Yamada, that the order was for help with shopping, that the consideration was 1,500 yen per hour, and that the evaluation of the orderee (Taro Yamada) was 3.5 on a 5-point scale.

If the order button 202 is selected on the order content display screen 200, the orderer terminal 30 sends the order request to the intermediary device 10. When the intermediary device 10 receives an order request from the orderer's terminal 30, it notifies the orderer's terminal 20, which is used by the order recipient (the orderee), that an order request has been placed.

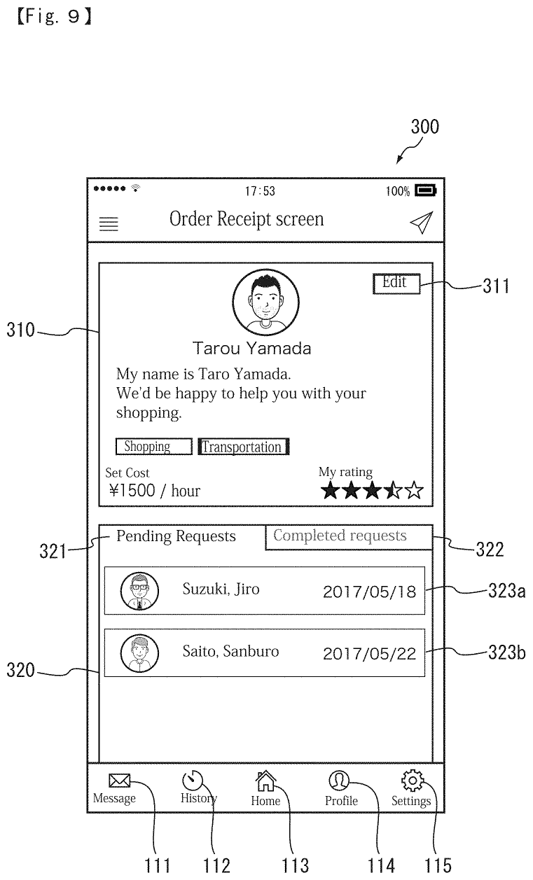

FIG. 9 is a schematic diagram showing an example of an order screen 300 displayed on the display portion 26 of the order-taking terminal 20. The order screen 300 shown in FIG. 9 has a display column 310 that displays information about the person who received the order and a display column 320 that displays information about the case in which the order request was received. The information displayed in the display column 310 includes the name of the contractor, a description of the order, the category of the order, the set price, and the evaluation of the contractor. The text introducing the order, the category, and the set price can be edited as appropriate on the edit screen (not shown) that transitions by selecting the edit button 311.

The information displayed in the display column 320 includes requests that are pending and requests that have been received. The pending request represents a case in which an order request has been received from the orderer's terminal 30 through an intermediary device 10, but a transaction between the orderer and the orderer has not yet been concluded. An already-ordered request represents a case in which an order request is received from the orderer's terminal 30 through an intermediary device 10 and a transaction is concluded between the orderer and the order receiver. The display between the pending request and the ordered request can be switched by selecting the tags 321, 322 provided at the top of the display column 320.

The order receipt screen 300 illustrated in FIG. 9 shows that order requests from “Jiro Suzuki” and “Saburo Saito” are registered as pending requests. When an orderer approves a request from “Jiro Suzuki,” for example, by selecting the label 323a that indicates the request, an approval screen (not shown) is displayed on the display portion 26 of the order receiver's terminal 20, and approval is given to the request through the displayed approval screen. The same is true when the order receiver approves a request from “Saburo Saito,” and by selecting the label 323b that indicates the request, an approval screen (not shown) is displayed on the display portion 26 of the order receiver's terminal 20, and approval is given to the request through the displayed approval screen.

In addition, in this embodiment, the order receiver can exchange messages with the orderer or with the system through the message screen that transitions when the message button 111 is selected, so that the orderer can make inquiries about receiving and accepting orders as appropriate.

If an order request (request) from an orderer is approved by the order receiver, the order receiver's terminal 20 notifies the intermediary device 10 that the order receiver has approved the request. If an order request from an orderer is approved, the intermediary device 10 performs the settlement process. Specifically, the intermediary device 10 sends screen data pertaining to the settlement screen to the orderer's terminal 30 from which the order is placed, thereby requesting payment of the costs required for the order.

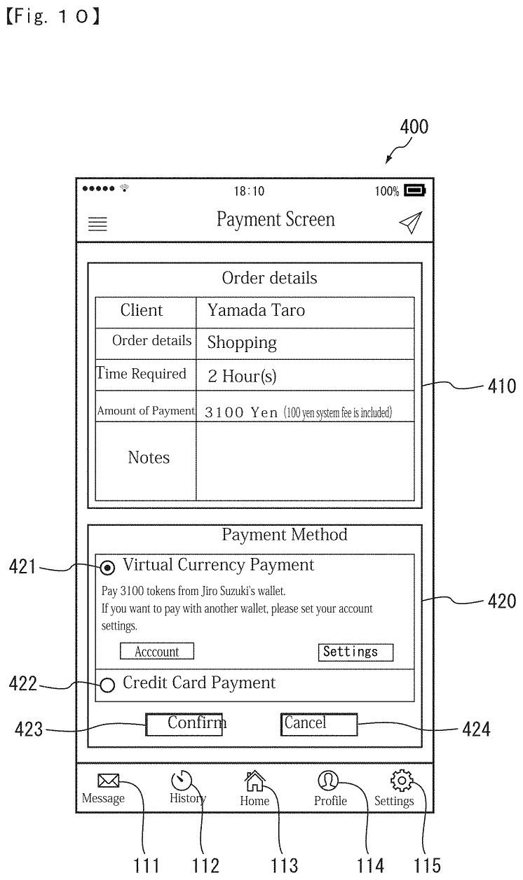

FIG. 10 is a schematic diagram showing an example of a settlement screen 400 displayed on the display portion 36 of the orderer's terminal 30. The settlement screen 400 shown in FIG. 10 has a display column 410 for displaying the contents of the order and a selection column 420 for accepting the selection of the settlement method. The information displayed in the display column 410 includes the recipient of the order, the contents of the order, the time required, the amount of payment, and remarks. In the present embodiment, the amount to be paid by the orderer is the consideration to the order receiver plus the system fee. The system fee may be a fixed amount, or it may be an amount that fluctuates in accordance with the consideration paid to the contractor.

The selection column 420 includes a selection button 421 for selecting a virtual currency settlement, a selection button 422 for selecting a credit settlement, a confirmation button 423 for executing the settlement using the selected settlement method, and a cancellation button 424 for canceling the settlement.

When the select button 421 is selected and the confirm button 423 is clicked, the settlement process using the virtual currency is performed. In virtual currency payment processing, the payment amount is paid from the virtual currency wallet owned by the orderer. The amount paid by the orderer includes the consideration paid to the order receiver and the system fee payable by the order receiver. For this reason, the virtual currency to be transferred from the orderer's wallet is first credited to the wallet of the system administrator (intermediary), and the system fee to be paid by the orderer is collected by the intermediary device 10.

Note that the account information of the wallet used by the orderer may be registered in advance in the user database 12A. Moreover, the wallet account may be set up in an application program that performs payment processing, or it may be set up in an application program dedicated to the wallet that operates in conjunction with the application program that performs payment processing. Furthermore, the payment process may be configured to be executed by displaying a code (e.g., QR code (registered trademark); Quick Response code) indicating information about the payment amount on the settlement screen 400 and reading the code on another terminal having a virtual currency wallet function.

In addition, the consideration paid to the awardee includes a system fee payable by the awardee. For this purpose, the intermediary device 10 collects the system fee payable by the orderee from the virtual currency deposited in the wallet of the system administrator (intermediary), and remits the virtual currency in the amount of the subtracted system fee from the wallet of the system administrator (intermediary) to the wallet of the orderee. The account information of the wallet used by the order taker may be registered in advance in the user database 12A. The system fee paid by the orderer may be a fixed amount, or it may be an amount that fluctuates according to the consideration paid to the orderer.

If the selection button 422 is selected at the orderer's terminal 30 and the confirmation button 423 is clicked, payment processing by credit card is performed. The content of payment processing using credit cards is similar to payment processing using virtual currencies. In the payment processing by credit card, the legal currency (real currency) corresponding to the amount received can be exchanged for virtual currency, a system fee is collected, and the virtual currency is then remitted to the orderer.

Explain a specific example of settlement processing. If the consideration from the orderer to the orderer is 3,000 yen in legal tender and the system fee is 100 yen in legal tender, a virtual currency (e.g., 3,100 tokens) equivalent to a total of 3,100 yen is paid from the orderer's wallet. In other words, the virtual currency equivalent to “3,100 yen” is transferred from the wallet of the orderer to the wallet of the intermediary. When a deposit is made to the wallet of the intermediary, the intermediary device 10 collects a virtual currency (100 tokens) equivalent to “100 yen” of the system fee to be paid by the orderer from the amount of the deposit, collects a virtual currency (100 tokens) equivalent to “100 yen” of the system fee to be paid by the orderer from the consideration to the orderer, and transfers the remaining virtual currency (2900 tokens) equivalent to “2900 yen” from the wallet of the intermediary to the wallet of the orderer.

The above procedure completes the settlement process for the transaction between the orderer and the order receiver. Upon completion of the settlement process, the order receiver may provide the goods or services provided by the transaction to the orderer, and the orderer may enjoy the goods or services provided by the order receiver.

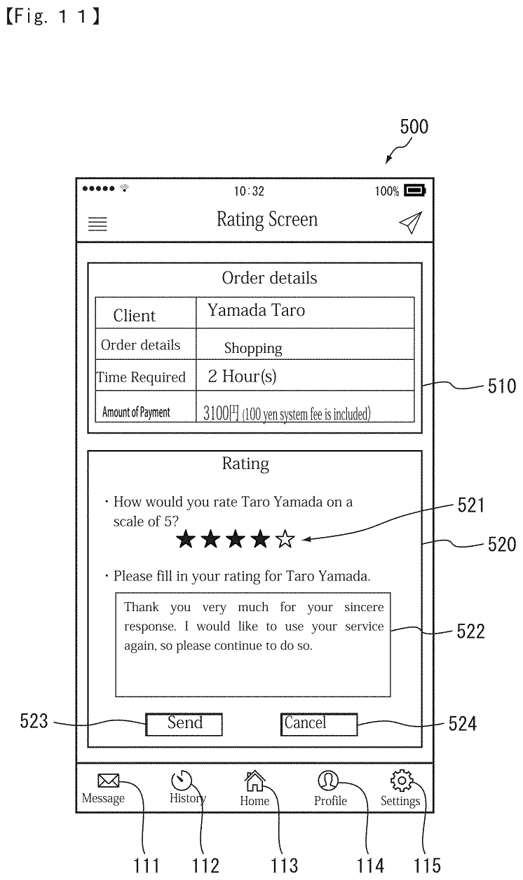

The intermediary device 10 sends screen data pertaining to the evaluation screen to the orderer's terminal 30 in order to obtain an evaluation of the orderer by the orderer at a suitable timing after the goods or services have been provided by the orderer to the orderer. FIG. 11 is a schematic diagram showing an example of an evaluation screen 500 displayed on the display portion 36 of the orderer's terminal 30. The evaluation screen 500 shown in FIG. 11 has a display column 510 for displaying information on the contents of an order and an evaluation column 520 for accepting evaluation from the orderer to the orderer. In the display column 510, for example, information such as the recipient of the order, the content of the order, the time required, and the amount of payment is displayed. In the evaluation column 520, there is a rating bar 521 to receive ratings for the orderer in five levels, an input column 522 to receive ratings for the orderer as text data, a send button 523 to send the input ratings, and a cancel button 524 to cancel the ratings.

The rating bar 521 comprises, for example, five radio buttons, and is configured so that an evaluation of the orderer can be set between evaluation 1 (the lowest evaluation) and evaluation 5 (the highest evaluation) by pressing each radio button. The input column 522 accepts the input of text data. The orderer can enter a text evaluation of the orderer using the control panel 35 of the orderer's terminal 30, and the evaluation of the orderer entered by the orderer is displayed in the input column 522. When the transmit button 523 is pressed, the ordering terminal 30 sends the five-level evaluation set in the rating bar 521 and the evaluation using the text entered in the input column 522 to the intermediary device 10.

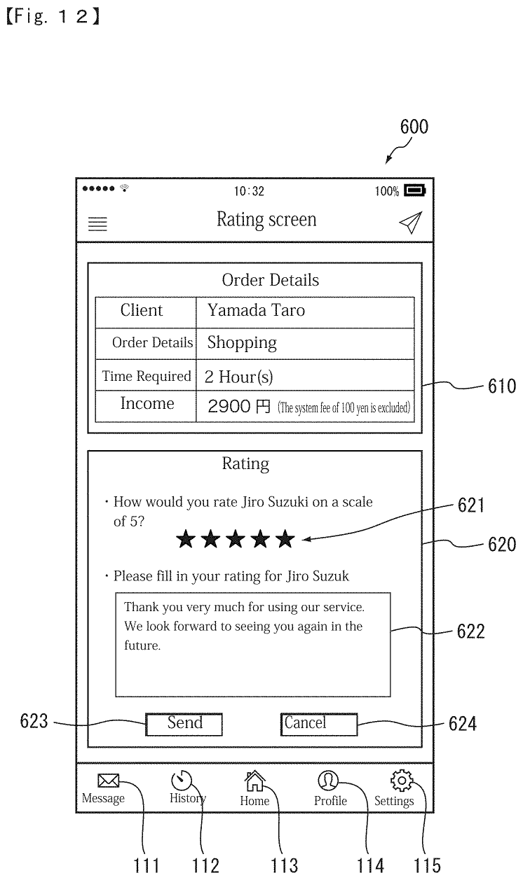

In addition, the intermediary device 10 transmits screen data pertaining to the evaluation screen to the orderer's terminal 20 in order to obtain an evaluation of the orderer by the orderer at a suitable timing after the goods or services have been provided by the orderer to the orderer. FIG. 12 is a schematic diagram showing an example of an evaluation screen 600 displayed on the display portion 26 of the order-taking terminal 20. The evaluation screen 600 shown in FIG. 12 has a display column 610 for displaying information on the contents of the order and an evaluation column 620 for accepting evaluation from the orderer to the orderer. In the display column 610, for example, information such as the requester (the person who placed the order), the order details, the time required, and the amount of income is displayed. In the evaluation column 620, there is a rating bar 621 that accepts ratings for the orderer in five levels, an input column 622 that accepts ratings for the orderer as text data, a send button 623 that sends the input ratings, and a cancel button 624 that cancels the setting of the ratings.

The rating bar 621 comprises, for example, five radio buttons, and is configured so that an evaluation of the order receiver can be set between evaluation 1 (lowest evaluation) and evaluation 5 (highest evaluation) by pressing each radio button. The input column 622 accepts the input of text data. The orderer can enter an evaluation of the orderer in text using the operation area 25 of the orderer's terminal 20, and the evaluation of the orderer entered by the orderer is displayed in the input column 622. When the transmit button 623 is pressed, the orderer terminal 20 transmits the five-level evaluation set in the rating bar 621 and the evaluation using the text entered in the input column 622 to the intermediary device 10.

In this embodiment, the evaluation of each user is stored in a distributed ledger shared by multiple nodes 40, 40, . . . , 40 in the network N, making it difficult to falsify the evaluation and providing a highly reliable and fair platform.

As one of the distributed ledgers, the technology represented by the blockchain, for example, can be used. In blockchain technology used for virtual currencies, transaction information (transactions) for virtual currencies broadcasted in the network is approved on behalf of one terminal in the network, and a block containing the transaction information is generated and registered in the existing blockchain. The absence of fraud in this process is verified by the entire system (i.e., other terminals participating in the network). In blockchain technology, the trustworthiness of information exchanged between participants is guaranteed by the process of consensus building within the network formed by the entire participants, and the soundness of the blockchain is maintained by preventing tampering, dual use, and other forms of fraud throughout the system.

In order to register the evaluation of each user (evaluation of the orderer by the orderer and evaluation of the orderer by the orderer) in the blockchain, for example, the intermediary device 10 in this embodiment broadcasts transaction data including the evaluation content to each node 40, 40, . . . 40 in the network N, with the intermediary device 10 as the source and the orderer or orderer as the destination (evaluation target). The broadcast evaluation is approved by a node 40 in network N. The broadcast evaluation is approved by a node 40 in network N. Said node 40 generates a block containing evaluation information and registers the generated block in the blockchain.

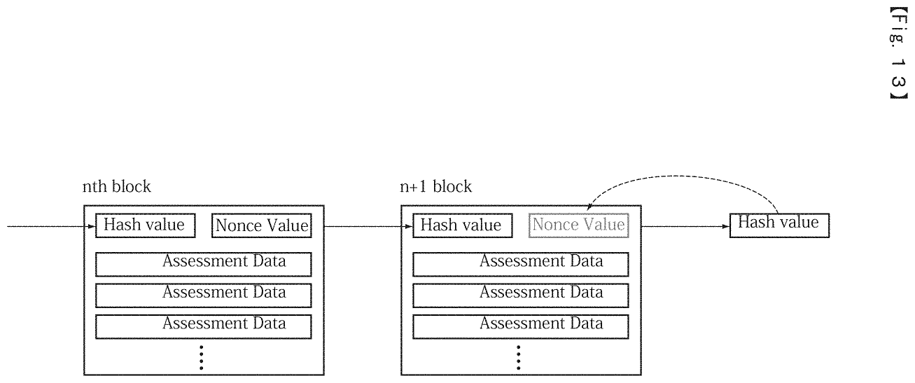

FIG. 13 is an illustrative diagram illustrating an example of registration by blockchain. In FIG. 13, a block of n represents a block at the end of the blockchain, and a block of n+1 represents a block in generation that is about to be added to a blockchain in which blocks up to n have been registered. The nth block contains the hash value of the previous block, the nonce value specific to the block, and the evaluation data broadcasted by the intermediary 10.

When a new block is to be added to a block chain in which blocks up to nth are registered, the node 40 performs a calculation (Proof of Work) to obtain a nonce value such that the hash value of the block satisfies a specific condition (e.g., a condition in which the first k bits of the hash value become 0). Upon successful computation, the node 40 registers a new block containing the hash value, nonce value, and evaluation data of the previous block in the blockchain.

In this embodiment, the form using the blockchain as an example of the decentralized ledger is explained, but the decentralized ledger in which the user's evaluation data is registered is not limited to the blockchain. For example, instead of a proof of work, it may be a distributed ledger using another consensus algorithm, such as a proof of stake. Even when other consensus algorithms, such as proof-of-stake, are used, the reliability of the system can be ensured without relying on the difficulty of predicting the hash value of a block in advance or on a specific management entity.

Also, in this embodiment, although the configuration is such that the user's evaluation data is stored in the distributed ledger, the configuration may be such that the information (transaction) of the transaction between the orderer and the order receiver is also stored in the distributed ledger.

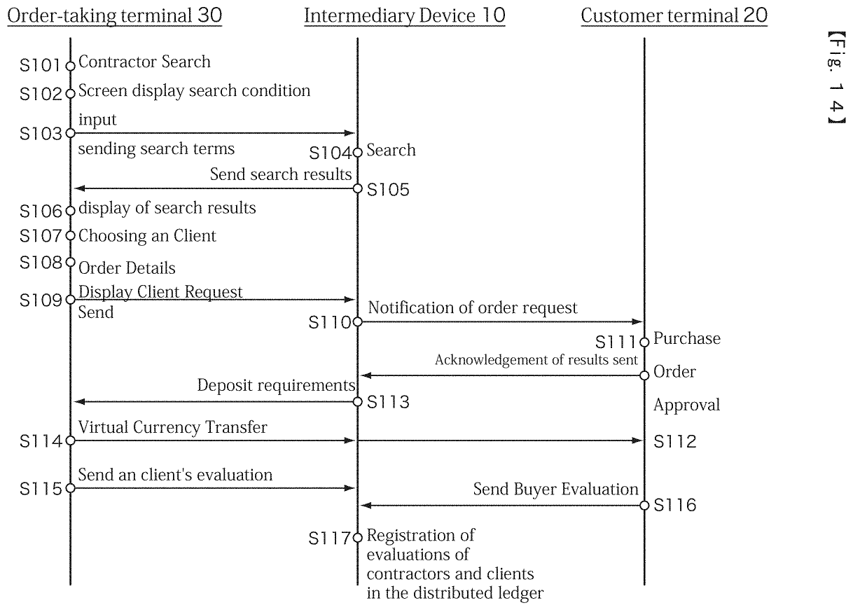

The following is a description of the operation of each device. FIG. 14 is a flowchart explaining the processing steps executed by the intermediary device 10, the orderer's terminal 20, and the orderer's terminal 30. The control portion 31 of the orderer's terminal 30 accesses the intermediary device 10 through the communication portion 33 and obtains data for the display screen from the intermediary device 10, causing the orderer search screen 100 to be displayed on the display portion 36 (step 101). The controller 31 accepts input of search conditions such as the category of the contents of the order and the attributes of the person placing the order through the operation part 35 (step S2), and transmits the accepted search conditions to the intermediary device 10 from the communication part 33 (step 103).

The control section 11 of the intermediary device 10 searches the order contents registration database 12B based on the search conditions received from the order taker's terminal 30 (step S104), and sends the search results including the order contents by the corresponding order taker to the order taker's terminal 30 from the communication section 13 (step S105).

The control portion 31 of the orderer terminal 30 displays the received search results on the orderer search screen 100 (step S106). If the controller 31 accepts the selection of an icon (order taker) to be displayed on the order taker search screen 100 (step S107), the controller 36 displays the order contents display screen 200 that includes the order contents of the order taker (step S108).

If the controller 31 receives an operation to press the order button 202 on the order content display screen 200, it transmits the order request to the intermediary device 10 from the communication part 33 (step S109).

When the control part 11 of the intermediary device 10 receives an order request from the orderer's terminal 30, it notifies the orderer's terminal 20 from the communication part 13 that an order request has been received from the orderer's terminal 30 (step S110).

The control portion 21 of the order receiving terminal 20 receives a notice of an order request, accepts the approval of the order request on the order screen 300 displayed on the display portion 26 (step S111), and transmits the approval result to the intermediary device 10 from the communication portion 23 (step S112).

When the control part 11 of the intermediary device 10 receives the approval result, it sends a payment request from the communication part 13 to the customer's terminal 30 (step S113).

The control portion 31 of the orderer's terminal 30 remits the virtual currency in an amount that includes the consideration to the orderer and the system fee in response to a deposit request from the intermediary device 10 (step S114). At this time, the intermediary device 10 collects the system fee charged to the orderer when relaying the remittance from the orderer to the orderer, and also collects the system fee charged to the orderer from the virtual currency remitted to the orderer.

The above procedure completes the settlement process for the transaction between the orderer and the order receiver. Upon completion of the settlement process, the order receiver may provide the goods or services provided by the transaction to the orderer, and the orderer may enjoy the goods or services provided by the order receiver.

The intermediary device 10 requests input of evaluations into the orderer's terminal 20 and the orderer's terminal 30 to obtain the evaluation of the orderer by the orderer and the evaluation of the orderer by the orderer at a suitable timing after the goods or services have been provided by the orderer to the orderer.

The control part 31 of the orderer terminal 30 transmits the evaluation from the orderer to the order receiver, which is input via the evaluation screen 500, to the intermediary device 10 from the communication part 33 (step S115). Similarly, the control portion 21 of the orderer's terminal 20 transmits the evaluation from the orderer to the order receiver, which is input via the evaluation screen 600, to the intermediary device 10 from the communication portion 23 (step S116).

When an evaluation from an orderer to an orderer is received from an orderer's terminal 30, or an evaluation from an orderer to an orderer is received from an orderer's terminal 20, the control section 11 of the intermediary 10 broadcasts the evaluation information to nodes 40, 40, . . . , 40 in the network N in order to register the evaluation of the orderer and the orderer in the distributed ledger (step S117). The broadcast evaluation information is approved by, for example, one node in network N and added to the blockchain by said node 40.

As described above, in this embodiment, the evaluation of each user can be stored in a distributed ledger shared by multiple nodes 40, 40, . . . , 40 in the network N. This makes it difficult to falsify the evaluation and makes it possible to provide an exceptionally reliable and fair platform.

In this embodiment, an intermediary device 10 obtains evaluations from an orderer to an orderer and from an orderer to an orderer, and broadcasts the evaluations from the intermediary device 10 to Network N. However, it may also be configured to broadcast the evaluations from an orderer's terminal 20 and an orderer's terminal 30 to Network N. In other words, when an evaluation from an orderer to an order receiver is accepted at the orderer's terminal 20, the accepted evaluation information is broadcast to the network N, and the evaluation information approved by the node 40 in the network N may be added to the blockchain. In addition, when an evaluation from an orderer to an orderer is accepted at the orderer's terminal 30, it may be configured to broadcast the accepted evaluation information to the network N and add the evaluation information approved by the node 40 in the network N to the blockchain.

Moreover, the node 40 sharing the distributed ledger may be configured by the orderer's terminal 20 or the orderer's terminal 30, and the orderer or the orderer with a high evaluation may be given the authority to execute the mining on a priority basis. The intermediary device 10 may, as an incentive for mining, pay a commission to the orderer or the order receiver who solves the search problem.

### Embodiment 2

In embodiment 2, each user is ranked based on the evaluation of each user, and the configuration that displays the user's information in a display style according to the user's rank is explained.

The intermediary device 10 of this embodiment form obtains evaluations of each user from the distributed ledger shared by the nodes 40, 40, . . . , 40 connected to the network N, and ranks each user based on the evaluations obtained. The intermediary device 10 may, for example, calculate an average value of a five-step evaluation (a number from 1 to 5) for each user, and rank the users in the order in which the average value of the calculated five-step evaluation is high. In addition, the intermediary device 10 may perform the ranking by considering the evaluation entered by the text. For example, if the text expressing the user's evaluation contains positive expressions, a (e.g., 0.5) may be added to the average value of the user's five-level evaluation, and if negative expressions are included, β (e.g., 0.2) may be subtracted from the average value of the five-level evaluation to obtain an overall evaluation, and the user may be ranked based on this overall evaluation. The intermediary device 10 may rank all users, or it may rank them by order takers, by orderers, by order categories, and by the attributes of each user. In addition, the intermediary device 10 may grant the user a virtual currency in an amount corresponding to the rank at a regular timing or each time an order is received and completed.

When the intermediary device 10 pertaining to embodiment 2 receives a search request for an orderly person from the orderer's terminal 30, the intermediary device 10 transmits the search results including the rank of the orderly person searched to the orderly person's terminal 30 so that the search results are displayed in rank order.

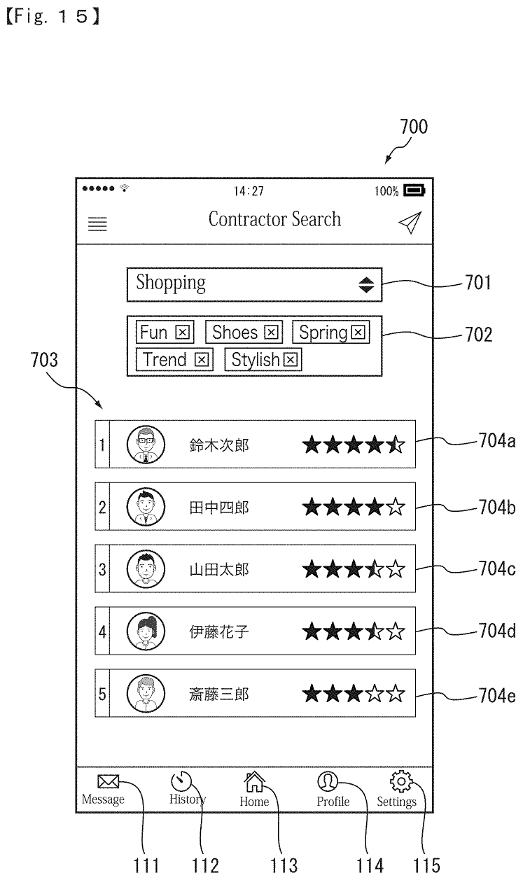

FIG. 15 is a schematic diagram showing an example of the orderer search screen 700 pertaining to embodiment 2. For example, the orderee search screen 700 of embodiment 2 includes a category selection column 701 for accepting a selection for an order category, an attribute setting column 702 for accepting a setting of an attribute required for the orderee, and a display column 703 for displaying the search results.

The orderer terminal 30 requests the intermediary device 10 to search for an appropriate subscriber when it receives a selection for an order category and a setting for the attributes of the subscriber through the subscriber search screen 700 displayed on the display portion 36. It is not necessary to set the attributes of the orderer at the time of the search request but may be configured to accept the selection of a category and make a search request based on the selected category.

If the intermediary device 10 receives a search request from the orderer's terminal 30, it accesses the user database 12A and the order content registration database 12B to search for the relevant orderer, and sends the information on the orderer that matches the search conditions to the orderer's terminal 30. Currently, the intermediary device 10 sends information including the rank of the orderer who matches the search conditions to the orderer's terminal 30.

The orderer terminal 30 displays the information of the orderer that matches the search conditions on the display portion 26 in an order according to the rank of the order receiver. In the example of the search result shown in FIG. 15, “Suzuki Jiro”, which has an average (or overall rating) of 4.5 on a 5-point scale, has the highest rank, followed by “Tanaka Shiro”, “Yamada Taro”, and . . . When any one of the labels 704a, 704b, . . . is selected, the orderer terminal 30 displays the order information display screen 200 as shown in FIG. 8 on the display block 26 and accepts the order request through the order information display screen. Since the operation after receiving an order request is the same as in embodiment 1, the explanation is omitted.

As described above, in embodiment 2, because the search result of an order taker is displayed in rank order, the order taker can preferentially select an order taker with a high rank (high evaluation) and place an order.

In the above example, the ranking information of the orderer is presented to the orderer; however, since the ranking performed by the intermediary device 10 is performed on all users, the ranking information of the orderer may be presented to the orderer.

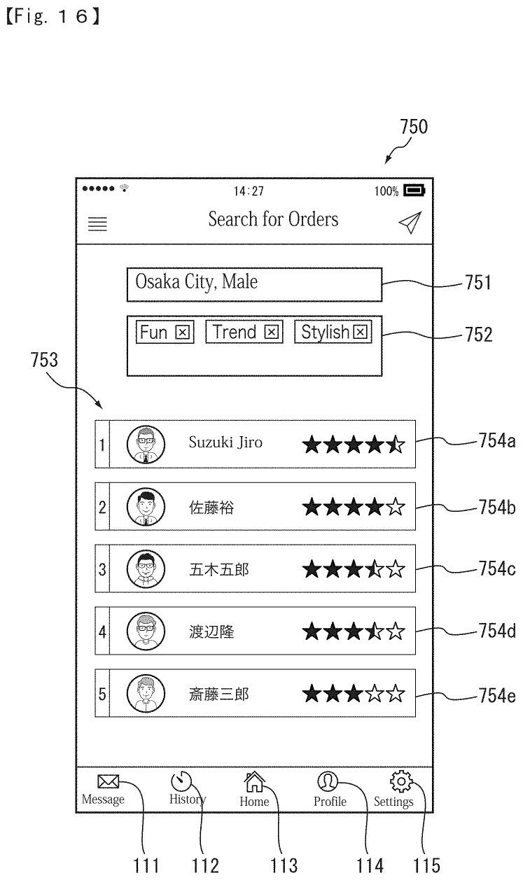

FIG. 16 is a schematic diagram showing an example of the purchaser search screen 750 pertaining to the embodiment 2. The purchaser search screen 750 includes, for example, an input column 7551 that accepts a search keyword, an attribute setting column 752 that accepts a setting of attributes to be requested by the purchaser, and a display column 753 that displays the search results.

If the orderer's terminal 20 receives the settings for the search keyword and the attributes of the orderer through the orderer search screen 750, it requests the intermediary device 10 to search for the relevant orderer. It is not necessary to set the attribute of the person who placed the order in the search request, but it may be configured to accept the input of search keywords and perform a search request based on the input search keywords.

When the intermediary device 10 receives a search request from the orderer's terminal 20, it accesses the user database 12A, searches for the relevant orderer, and sends the information on the orderer that matches the search conditions to the orderer's terminal 20. Currently, the intermediary device 10 sends information, including the rank of the recipient that matches the search conditions, to the recipient's terminal 20.

The order in which the orderer's information that matches the search conditions is displayed on the display part 26 in an order according to the rank of the orderer. In the example of the search result shown in FIG. 16, “Suzuki Jiro” with an average (or overall rating) of 4.5 on a 5-point scale has the highest rank, followed by “Yutaka Sato”, “Gokigoro”, and so on. When any one of the labels 754a, 754b, . . . indicating an ordering person is selected, the information of the selected ordering person may be displayed on the display portion 26.

In the present embodiment, the intermediary device 10 is configured to rank each user, but it may be configured to obtain the evaluation information of the retrieved user from the distributed ledger by the orderer's terminal 20 or the orderer's terminal 30, and to rank the user by a program installed on the orderer's terminal 20 or the orderer's terminal 30.

### Embodiment 3

In embodiment 3, when an orderer sets the receipt of consideration to a legal tender, the configuration of exchanging the virtual currency for the legal tender and depositing the exchanged legal tender into the account of the orderer is described.

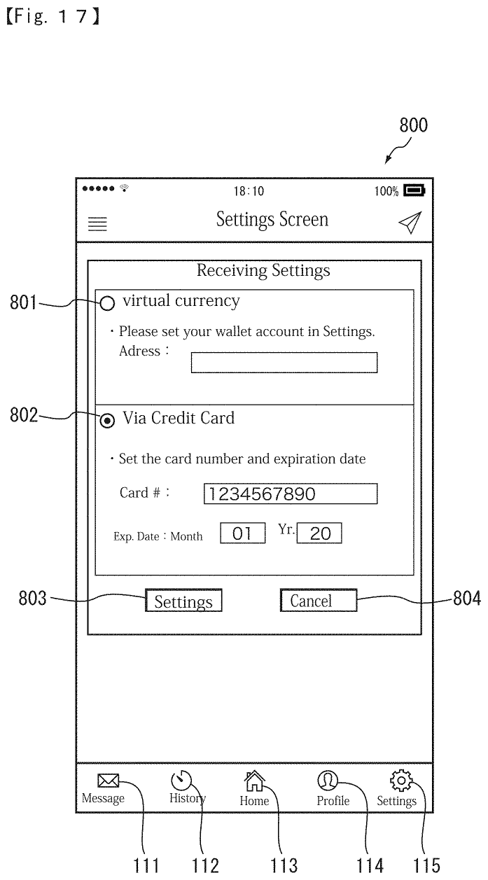

FIG. 17 is a schematic diagram showing an example of the setting screen 800 for setting the receipt of consideration. The setting screen 800 shows an example of a screen that is displayed when a setting item for the receiving setting is selected from among the setting items displayed by operating the setting button 115. The setting screen 800 includes a selection button 801 for selecting the receipt of the consideration in virtual currency, a selection button 802 for selecting the receipt of the consideration in legal currency via credit card, a setting button 303 for confirming the setting, and a cancellation button 304 for canceling the setting.

If the selection button 801 is selected, the account (address) of the wallet is entered, and then the setting button 803 is pressed and operated, the receipt of the consideration is set to the virtual currency. In this embodiment, since remittance in virtual currency is performed, the virtual currency remitted from the orderer to the orderee is credited to the account in the wallet set in the configuration screen 800.

If the selection button 802 is selected, the credit card number and the expiration date are entered, and then the setting button 802 is pressed and operated, the receipt of the consideration is set to the legal tender. In the present embodiment, since remittance in virtual currency is performed, the virtual currency remitted from the order receiver to the orderer is exchanged into legal tender by the intermediary device 10, and the exchanged legal tender is credited to an account designated by a credit card. Furthermore, it is not necessary for the intermediary device 10 to exchange money into legal tender, and it is possible to request an external device to exchange money.

As described above, in the present embodiment, the user can arbitrarily choose whether to receive in virtual currency or legal currency.

### Embodiment 4

In embodiment 4, a configuration in which an intermediary device 10 mediates a virtual currency loan transaction between users is described.

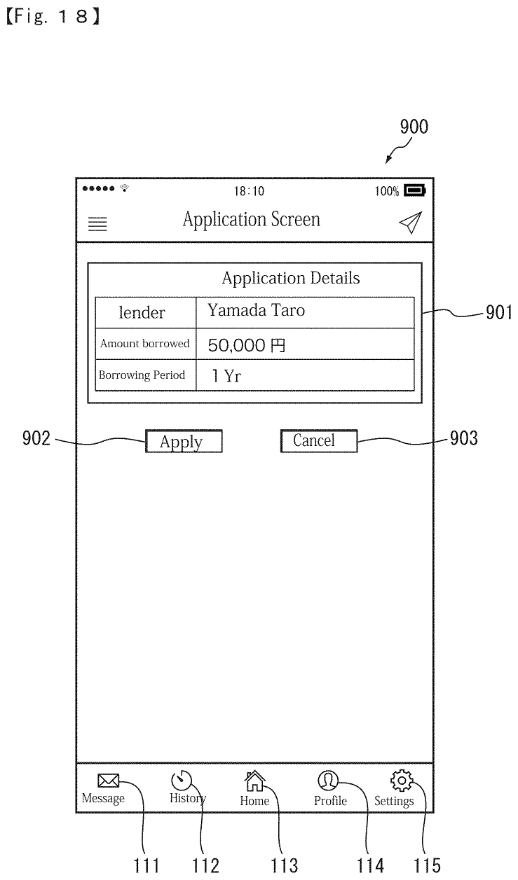

FIG. 18 is a schematic diagram showing an example of the borrowing application screen 900. The borrowing application screen 900 is an example of a screen displayed on a terminal when a user applies for a virtual currency borrowing to another user. In the following, it is assumed that the applicant for the borrowing is using the orderer's terminal 30 and the user of the lender is using the orderer's terminal 20.

If the orderer terminal 30 accepts a predetermined operation to call up the borrowing application screen 900, the control portion 31 displays the borrowing application screen 900 as shown in FIG. 18 on the display portion 36. The borrowing application screen 900 has, for example, an application entry column 901, an application button 902, and a cancellation button 903. If the application details, including the lender, the amount borrowed, and the borrowing period, are entered in the application entry column 901 and the application button 902 is pressed, the control unit 31 transmits the entered application details to the intermediary device 10 from the communication part 33. If the Cancel button 903 is pressed, the application for the borrowing is cancelled.

When the intermediary device 10 receives an application sent from the orderer's terminal 30, it searches the lender described in the application from the user database 12A and sends the application contents to the orderer's terminal 20 used by the user of the searched lender. At this time, the intermediary device 10 may set an interest rate on the amount borrowed and transmit the set interest rate information together with it. In addition, the intermediary device 10 may obtain an evaluation of the applicant from the distributed ledger shared by the nodes 40, 40, . . . , 40 connected to the network N, and may transmit the obtained evaluation together with the application contents.

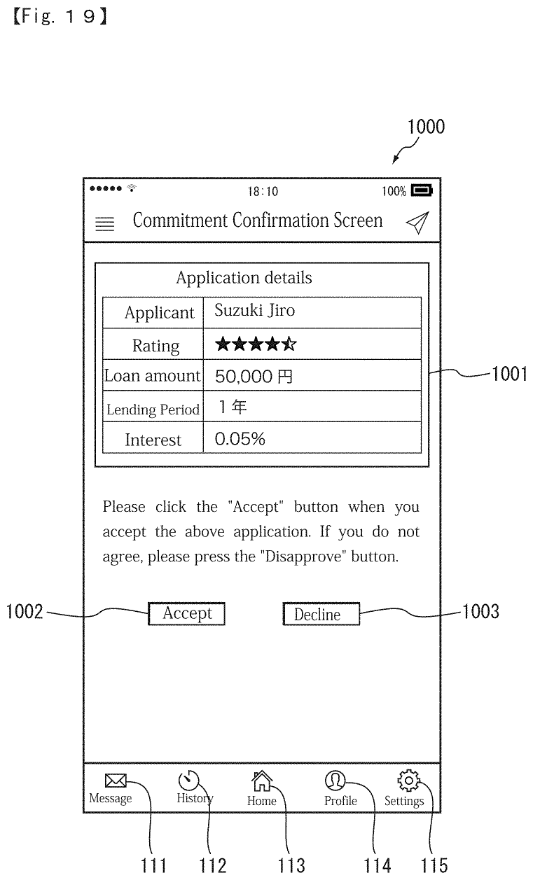

If the order receiver terminal 20 receives the contents of the application through the intermediary device 10, it confirms whether it accepts the contents of the application. FIG. 19 is a schematic diagram showing an example of the approval confirmation screen 1000. The approval confirmation screen 1000 includes a display column 101, an approval button 102, and a non-approval button 103. The contents of the application from the applicant are displayed in the display column 1001. Also, in the display column 101, information on the interest set by the intermediary device 10 may be displayed, and information on the evaluation of the applicant transmitted by the intermediary device 10 may be displayed.

If the acceptance button 102 is pressed, the order taker terminal 20 notifies the intermediary device 10 that the application has been accepted. If the reject button 103 is pressed, the orderer terminal 20 notifies the intermediary device 10 that the application has not been accepted.

When the intermediary device 10 receives a notification that an application has been accepted, it notifies the orderer terminal 30 that the applicant is using and requests the borrower who accepted the application to pay the amount of the loan. When a virtual currency equivalent to the amount borrowed is credited to a deposit request, the intermediary 10 transfers the virtual currency equivalent to the amount borrowed to an account in the virtual currency wallet used by the applicant.

Furthermore, the intermediary device 10 may determine whether or not repayment has been completed within the borrowing period set by the applicant, and if repayment has not been completed, the intermediary device 10 may send a message urging repayment to the orderer's terminal 30. Moreover, the intermediary device 10 may be configured to collect a predetermined fee from the interest portion of the repayment amount to be repaid to the borrower.

### Embodiment 5

In embodiment 5, a configuration in which the intermediary device 10 performs user authentication is described.

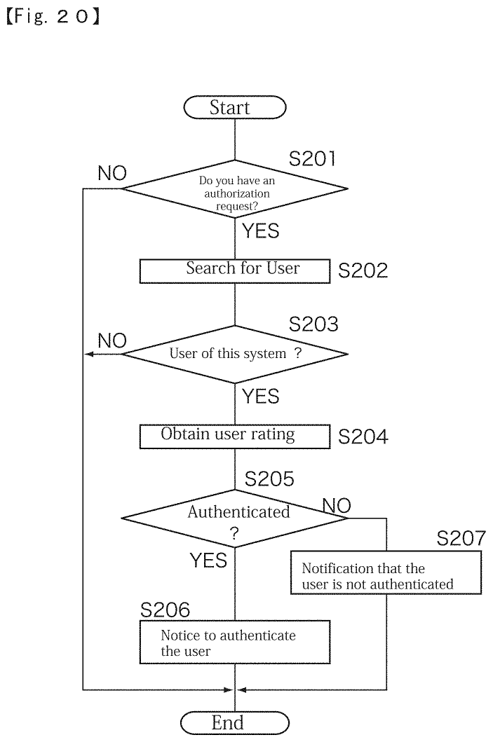

FIG. 20 is a flowchart explaining the processing procedure of user authentication executed by the intermediary device 10 pertaining to embodiment 5. The control part 11 of the intermediary 10 determines whether it has received the user's authentication request through the communication part 13 (step S1). The source of the authentication request is not limited to the order receiver's terminal 20, the orderer's terminal 30, and the node 40, but may be any terminal or server that can communicate with the intermediary device 10. If no authentication request is received (S1: NO), the control unit 11 terminates the process according to this flowchart without executing the following process.

When an authentication request is received (S1: YES), the control unit 11 searches for the relevant user from the user database 12A (S2) and determines whether the user is a user of the transaction intermediary system of this embodiment (303). If it is judged that the user is not a user of the transaction intermediary system pertaining to the form of this embodiment (S03: NO), the control unit 11 terminates the processing according to this flowchart without executing the following process.

When it is judged that the user is a user of the transaction intermediary system of this embodiment form (S 2033: YES), the control unit 11 obtains the evaluation of the user concerned from the distributed ledger shared by the nodes 40, 40, . . . , 40 connected to the network N (step 204).

Next, the control unit 11 determines whether to authenticate the user based on the evaluation obtained (step S205). For example, if the acquired evaluation (the average value of the five-level evaluation or the overall evaluation that takes into account the evaluation entered in the text) is above a predetermined threshold value (e.g., 3.0 or more), the control unit 11 judges that the user is authenticated. Also, the control portion 11 may count the number of times each user has used the system and determine whether or not to authenticate the user based on the relationship between the number of times the system has been used and the size of the threshold set for the number of times the system has been used.

If it is determined that the user is to be authenticated (S 205: YES), the control unit 11 notifies the source of the authentication request of the fact that the user is to be authenticated (S 206). On the other hand, if it is determined that the user is not to be authenticated (S 205: NO), the control unit 11 notifies the source of the authentication request that the user is not to be authenticated (S 207).

As described above, in this embodiment, the authentication of each user can be judged based on the evaluation stored in the distributed ledger.

### Embodiment 6

In embodiment 6, an example of application to a temporary staffing service that dispatches personnel from a client (dispatching agency, etc.) to an ordering party (client) is described. In this embodiment, the evaluation of the order receiver and the orderer by the dispatcher dispatched by the orderer to the order receiver, and the evaluation of the orderer and the order receiver to the dispatcher are distributed and stored in multiple nodes 40, 40, . . . 40, . . . 40 connected to the network N.

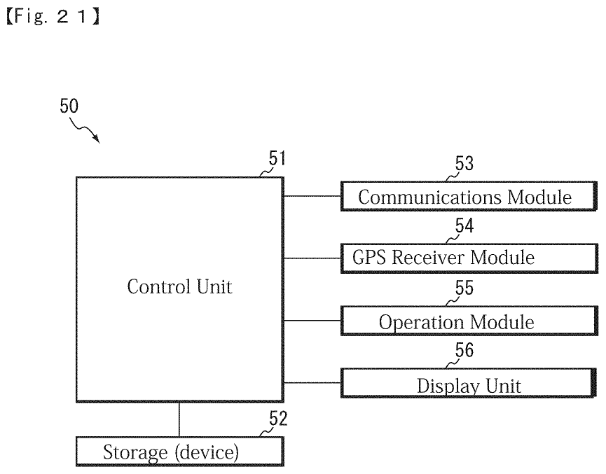

FIG. 21 is a block diagram explaining the internal configuration of the dispatcher terminal 50 used by the dispatcher. The dispatcher terminal 50 is a terminal device, such as a smartphone or a personal computer, and is equipped with a control unit 51, a storage unit 52, a communication unit 53, a GPS receiver 54, an operation unit 55, and a display unit 56. The operation of the above hardware components of the dispatcher terminal 50 is the same as the operation of the hardware components of the order receiver terminal 20 and the orderer terminal 30, so this explanation is omitted.

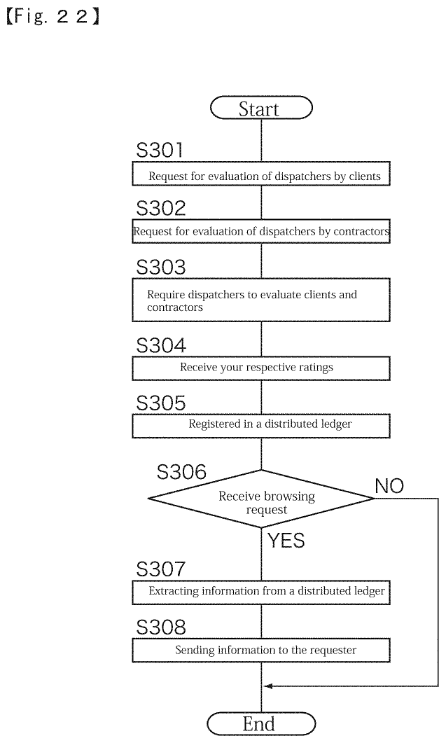

FIG. 22 is a flowchart explaining the processing steps executed by the intermediary device 10 pertaining to the embodiment 6. The intermediary device 10 mediates the receipt and ordering of the temporary staffing service provided by the client and completes the settlement process for the transaction between the client and the client, in the same manner as in embodiment 1. When the settlement process is complete, a dispatcher is dispatched from the orderer to the order receiver.

The intermediary device 10 requests the evaluation of the dispatcher by the orderer, the evaluation of the dispatcher by the orderer, and the evaluation of the order receiver and the orderer by the dispatcher at a suitable timing after the dispatch of the dispatcher from the order receiver to the orderer (steps 301 to 303). In the flowchart of FIG. 22, the order in which the orderer evaluates the dispatcher, the order receiver evaluates the dispatcher, and the orderer evaluates the order receiver and the orderer is not limited to the flowchart of FIG. 22.

The ordering terminal 30 accepts the input of an evaluation of the dispatcher in response to a request from the intermediary device 10. At this time, the orderer's terminal 30 displays an evaluation screen similar to the evaluation screen 500 described in embodiment 1 and accepts the evaluation of the dispatcher through the displayed evaluation screen. The orderer terminal 30 transmits the evaluation received through the evaluation screen to the intermediary device 10 from the communication part 33. The same applies to the case where the order receiver's terminal 20 and the dispatcher's terminal 50 accept the evaluation.

The intermediary device 10 receives evaluations sent from the orderer's terminal 30, the order receiver's terminal 20, and the dispatcher's terminal 50, respectively (step 304). In other words, the dispatcher's evaluation by the orderer is received from the orderer's terminal 30. In addition, an evaluation of the dispatcher by an order receiver is received from the order receiver's terminal 20. In addition, the dispatcher terminal 50 receives the evaluation of the orderer and the acceptor by the dispatcher.

When the intermediary device 10 receives the evaluation sent from the orderer's terminal 30, the order receiver's terminal 20, and the dispatcher's terminal 50, it broadcasts the evaluation information to the nodes 40, 40, . . . , 40 in the network N in order to register the evaluation of the dispatcher by the orderer and the order receiver and the evaluation of the orderer and the order receiver by the dispatcher in the distributed ledger (step 305). The broadcast evaluation information is approved by, for example, one node in network N and added to the blockchain by said node 40.

Next, the intermediary device 10 determines whether it has received a viewing request from a requesting source (not shown) with viewing authority (step 306). At this time, the control portion 11 can determine whether the requesting party has the viewing privileges by using a known method. For example, the control portion 11 may request input of an identifier and a password to identify the requesting party, and if the requesting party can be authenticated by the input identifier and password, the control portion 11 may determine that the requesting party has viewing privileges. Moreover, when the sender of the viewing request is a pre-registered terminal or has a pre-registered communication address, the control portion 11 may determine that the requestor has the viewing authority. The viewing authority may be given to a specific client or may be given to a management company that manages one or more dispatchers. Furthermore, it may be configured to give viewing authority to a user or company that has paid for viewing. If it is judged that the viewing request has not been received in step 306 (S306: NO), the control unit 11 terminates the processing according to this flowchart.

When a viewing request is received from a requestor with viewing privileges (S306: YES), the control unit 11 accesses the node 40 connected to the network N and extracts the necessary information from the distributed ledger (S307). For example, when the evaluation of a dispatcher is for viewing, the control block 11 can extract the necessary information from the distributed ledger by retrieving information using the ID identifying the dispatcher as a key. The control unit 11 transmits the information extracted from the distributed ledger to the source of the viewing request (step S308). For example, when a user gets a rating for a dispatcher, the user may display the rating of the dispatcher by the orderer and order receiver separately, or the overall rating of the dispatcher by the orderer and the order receiver together.

As described above, in this embodiment, by storing the evaluation of the dispatcher by the orderer and the order receiver and the evaluation of the order receiver and the order receiver by the dispatcher in a distributed ledger, it is difficult to falsify the evaluation, and it is possible to provide a highly reliable and fair platform.

In this embodiment, the evaluation of the dispatcher by the orderer and the order receiver and the evaluation of the order receiver and the order receiver by the dispatcher are stored in the distributed ledger, but as in embodiment 1, it is also possible to store the evaluation of the order receiver and the order receiver together in the distributed ledger.

### Embodiment 7

In embodiment 7, a configuration in which an orderer for goods or services to be provided by an order receiver is determined by bidding is described.

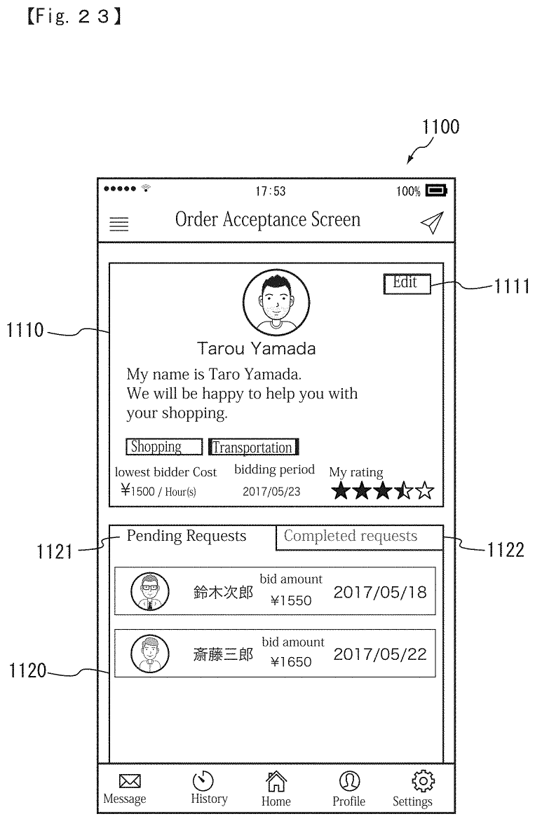

FIG. 23 is a schematic diagram showing an example of an order screen 1100 displayed on the display portion 26 of the order-taking terminal 20. The order screen 1100 shown in FIG. 23 has a display column 1110 for information about the person who received the order and a display column 120 for information about a case in which an order request was received. The information displayed in the display column 1110 includes the name of the contractor, a description of the order, the category of the order, the minimum bid price set by the contractor, the bidding period, and the evaluation of the contractor. The text introducing the order, the category, the minimum bid price, and the bid period can be edited appropriately on the edit screen (not shown) that transitions by selecting the edit button 1111.

The information displayed in the display column 1120 includes pending requests and requests that have been received. Pending requests include information on requests that have been bid on, but for which the winning bidder has not been determined. The request that has already been received includes information on the request for which an order request was received from the order receiver's terminal 30 through the intermediary device 10 and a transaction was concluded between the orderer and the order receiver. The display between a pending request and an ordered request can be switched by selecting the tags 1111, 1122 provided at the top of the display column 11220. In the present embodiment, the successful bidder is determined by the intermediary device 10 after a bidding period has elapsed.

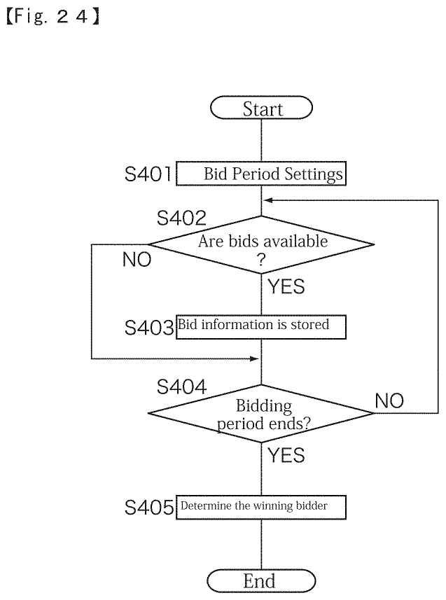

FIG. 24 is a flowchart explaining the processing steps executed by the intermediary device 10 pertaining to embodiment 7. The control unit 11 of the intermediary 10 sets a bidding period based on the content of the order received by the bidder (step 401). Next, the control unit 11 determines whether a bid has been accepted from the orderer's terminal 30 via the communication part 13 (step 402).

If it is judged that no bids have been accepted (S402: NO), the control unit 11 moves to step S404 described later. If it is determined that a bid has been received from the orderer's terminal 30 (S 402: YES), the control unit 11 stores the bid information including the bid amount set by the orderer in the memory part 12 (S 403).

Next, the control unit 11 determines whether the bidding period has ended by referring to the output of the internal clock (step 404). If it is judged that the bidding period has not ended (S404: NO), the control unit 11 returns to step 402.

If it is judged that the bidding period has ended (S404: YES), the control unit 11 determines the successful bidder from among the bidders who have accepted the bids (step S405). The control unit 11 may determine the bidder with the highest bid amount as the successful bidder. In addition, the control unit 11 may determine the successful bidder based on the amount of the bid by the orderer and the evaluation of the order receiver. For example, the control portion 11 may determine the bidder with the highest bid value among the purchasers whose evaluation is higher than a predetermined value, and may determine the purchaser with the highest cumulative value between the bid value and the evaluation as the successful bidder. Furthermore, the bid amount by the orderer and the evaluation by the orderer are notified to the orderer's terminal 30, and the successful bidder is determined by the selection of the orderer.

The process after the successful bidder is determined is the same as in embodiment 1, and the control unit 11 mediates the settlement process between the orderer (successful bidder) and the orderer, and executes the process of storing the evaluation of the orderer by the order receiver and the evaluation of the order receiver by the orderer in the distributed ledger.

As described above, in embodiment 7, the orderer can be determined by bidding.

### Embodiment 8

In embodiment 8, the configuration for accepting orders by multiple purchasers for a single order object is explained.

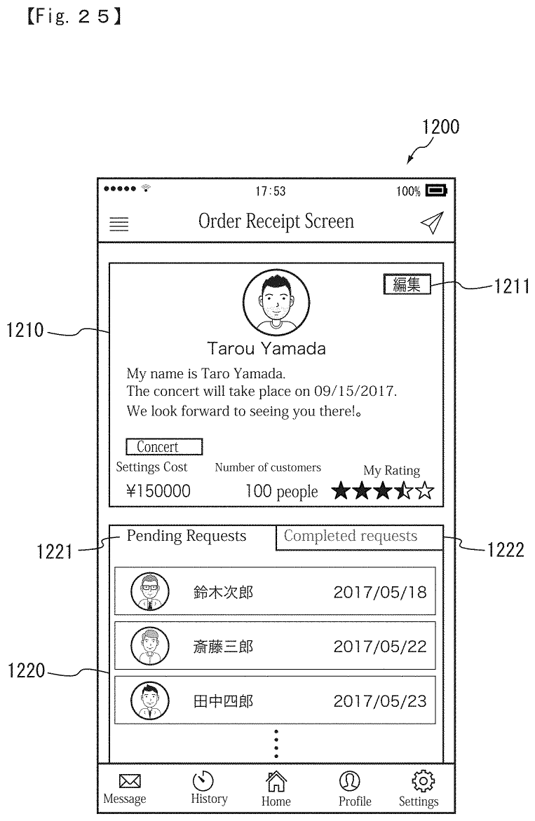

FIG. 25 is a schematic diagram showing an example of an order screen 12000 displayed on the display portion 26 of the order-taking terminal 20 in embodiment 8. The order screen 120 shown in FIG. 25 includes a display column 12110 for information about the person who received the order and a display column 12220 for information about a case in which an order request was received. The information displayed in the display column 1210 includes the name of the recipient, a description of the order, the category of the order, the set price, the number of current recipients, and the evaluation of the recipient. The text introducing the order, the category, and the set price can be edited as appropriate on the edit screen (not shown) that transitions by selecting the edit button 1211. In addition, the number of current purchasers represents the number of purchasers who have accepted orders at that time for the goods or services provided by the purchaser (in the example of FIG. 25, the holding of a concert).

The information displayed in the display column 12220 includes requests that are pending and requests that have been received. The pending request represents a case in which an order request has been received from the orderer's terminal 30 through an intermediary device 10, but a transaction between the orderer and the order receiver has not yet been concluded. The order receipt screen 1200 illustrated in FIG. 25 shows that order requests from “Jiro Suzuki”, “Saburo Saito”, “Shiro Tanaka”, etc. are registered as pending requests. An already-ordered request represents a case in which an order request is received from the orderer's terminal 30 through an intermediary device 10 and a transaction is concluded between the orderer and the order receiver. The display between a pending request and an ordered request can be switched by selecting the tags 1221, 1222 provided at the top of the display column 1222.

When the order period set by the order taker expires, the intermediary device 10 determines the number of people to place an order, determines the price to be charged for each person to place an order, and executes the settlement process. The intermediary device 10 transmits screen data pertaining to the settlement screen to one or more orderer terminals 30 of the orderer, thereby requesting payment of the costs required to place an order.

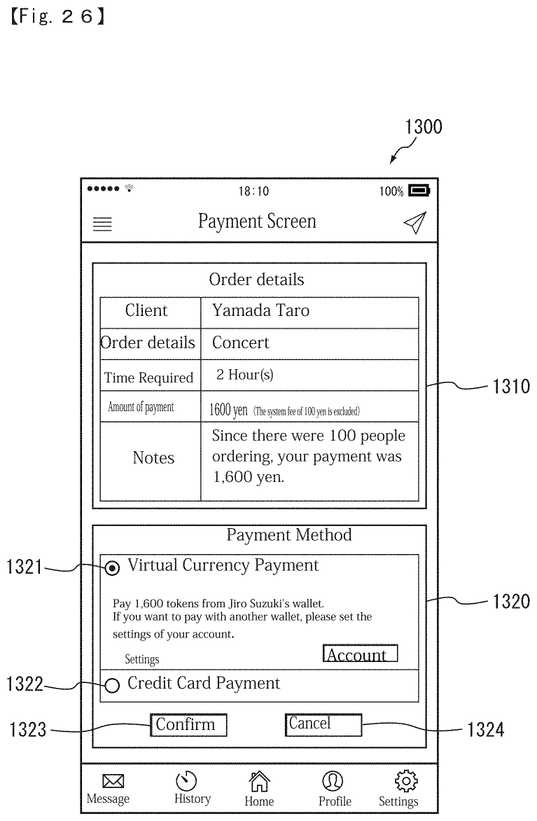

FIG. 26 is a schematic diagram showing an example of the settlement screen 13000 displayed on the display portion 36 of the orderer's terminal 30 in embodiment 8. The settlement screen 130 shown in FIG. 26 has a display column 1310 for displaying the contents of the order and a selection column 1320 for accepting the selection of the settlement method. The information displayed in the display column 1310 includes the recipient of the order, the content of the order, the time required, the amount of payment, and remarks. In the present embodiment, the amount to be paid by the orderer is the consideration to the order receiver plus the system fee. The system fee may be a fixed amount, or it may be an amount that fluctuates in accordance with the consideration paid to the contractor.

The selection column 1320 includes a selection button 1321 for selecting a virtual currency settlement, a selection button 1322 for selecting a credit settlement, a confirmation button 1323 for executing the settlement using the selected settlement method, and a cancellation button 1324 for canceling the settlement.

When the selection button 1321 is selected and the confirm button 1323 is pressed, the settlement process using the virtual currency is performed. In virtual currency payment processing, the payment amount is paid from the virtual currency wallet owned by the orderer. The amount paid by the orderer includes the consideration paid to the order receiver and the system fee payable by the order receiver. For this reason, the virtual currency to be transferred from the orderer's wallet is first credited to the wallet of the system administrator (intermediary), and the system fee to be paid by the orderer is collected by the intermediary device 10.

In addition, the consideration paid to the awardee includes a system fee payable by the awardee. For this purpose, the intermediary device 10 collects the system fee payable by the orderee from the virtual currency deposited in the wallet of the system administrator (intermediary), and remits the virtual currency in the amount of the subtracted system fee from the wallet of the system administrator (intermediary) to the wallet of the orderer. The account information of the wallet used by the order taker may be registered in advance in the user database 12A. The system fee paid by the order receiver may be a fixed amount, or it may be an amount that fluctuates according to the consideration paid to the orderer.

If the selection button 1322 is selected and the confirmation button 1323 is clicked at the orderer's terminal 30, the payment processing by credit card is performed. The content of payment processing using credit cards is similar to payment processing using virtual currencies. In the payment processing by credit card, the legal currency (real currency) corresponding to the amount received can be exchanged for virtual currency, a system fee is collected, and the virtual currency is then remitted to the order receiver.

Explain a specific example of settlement processing. The consideration for the goods or services (in the example of FIG. 26, the holding of a concert) set by the Orderer shall be “15,000 yen”. In contrast, if the number of persons receiving an order is set at 100, the intermediary device 10 may determine a payment amount of “1,500 yen” per person who places an order. If the system fee is set at “100 yen” in legal tender, the intermediary device 10 requests payment of a virtual currency (e.g., 1600 tokens) equivalent to a total of “1600 yen” to each orderer. In response to a request from the intermediary device 10, a virtual currency equivalent to “1600 yen” is transferred from the wallet of each orderer to the wallet of the intermediary. When a deposit is made to the wallet of the intermediary, the intermediary device 10 collects a virtual currency (100 tokens) equivalent to “100 yen” of the system fee to be paid by each orderer from the amount of the deposit. Through such a settlement process, the intermediary device 10 obtains the consideration to be paid to the order taker from each order taker. The intermediary device 10 collects a virtual currency (100 tokens) equivalent to “100 yen” of the system fee payable by the order receiver from the consideration to the orderer, and transfers the remaining virtual currency (149900 tokens) equivalent to “149900 yen” from the wallet of the intermediary to the wallet of the orderer.

The above procedure completes the settlement process for the transaction between the ordering party and multiple ordering parties. Upon completion of the settlement process, the ordering party may provide the goods or services provided by the transaction to the orderer, and the orderer may enjoy the goods or services provided by the order receiver.

The embodiments disclosed herein should be illustrative in all respects and not restrictive. The scope of the invention is indicated by the scope of the claims, not in the sense set forth above, and is intended to include all changes in the meaning and scope equal to and within the scope of the claims.

1-18. (canceled)

19. An intermediary method for intermediary transactions of goods or services between an orderer and an order receiver using a computer communicatively connected to an orderer's terminal and an order receiver's terminal, comprising:
sending information on goods or services to be ordered to the order receiver's terminal;
accepting the selection of goods or services to be ordered through the orderer's terminal;
processing a settlement for receiving and ordering the selected goods or services;
receiving the evaluation of the order receiver by the orderer who placed the said goods or services and the evaluation of the orderer by the order receiver from both the orderer's terminal and the order receiver's terminal; and
performing the process of storing the received evaluations of the orderer and the order receiver in a distributed ledger by the computer.

20. The intermediary method according to claim 19, further comprising:
ranking each user, including the said orderer and the said order receiver, based on the evaluation stored in the said distributed ledger by the computer; and
sending the order receiver's ranking information for each type of said goods or services along with the information on the goods or services to be ordered to the said orderer's terminal.

21. The intermediary method according to claim 20, further comprising:
executing a process of granting virtual currency to each user according to the ranking of each user by the computer.

22. The intermediary method according to claim 19,
wherein said service includes a personnel dispatching service for dispatching personnel from an order receiver to an orderer,
wherein said evaluation of said orderer and said order receiver for a dispatched person dispatched from said orderer is received from said orderer's terminal and said order receiver's terminal, said evaluation of said orderer and said order receiver by said dispatcher is received from said dispatcher's terminal, and said evaluation of said orderer and said order receiver for said dispatcher and said evaluation of said orderer and said order receiver and said evaluation of said orderer and said order receiver by said dispatcher is stored in a distributed ledger by said computer.

23. The intermediary method according to claim 22, further comprising:
transmitting the evaluation information stored in the distributed ledger to the requesting party in response to a request for inspection from the requesting party having inspection authority by the computer.

24. The intermediary method according to claim 19, further comprising:
executing a process of accepting one or more bids for said order subject, determining a successful bidder for said order subject based on the bids received, and accepting orders from said successful bidder.

25. The intermediary method according to claim 19, including requesting payment of a virtual currency in an amount equal to the consideration for said goods or services set by said orderer and a commission to said order receiver, collecting a commission to said order receiver and said orderer from the amount of payment made in response to said request processing, and remitting a virtual currency in an amount equal to the amount of said entry minus said commission to said order receiver and said orderer to an account set by said orderer.

26. The intermediary method according to claim 19, further comprising:
receiving orders from a plurality of purchasers for a single order object by the computer; and
executing payment processing according to the number of purchasers by the computer.

27. The intermediary method according to claim 26, wherein said settlement process includes requesting each orderer to deposit a virtual currency in an amount equal to the consideration for said goods or said services set by said orderer divided by the number of said order receivers and a commission to each order receiver, collecting a commission to said order receivers and said orderers from the amount of payment received in response to said request process, and remitting the virtual currency in an amount equal to the amount of said entry minus the commission to said order receivers and said orderers to an account set by said orderer.

28. The intermediary method according to claim 25, further comprising:
receiving a request for a change of the deposit method from the deposit of virtual currency to the deposit of legal currency by the computer;
when the computer receives the request for a change of the deposit method, requesting the deposit in legal currency in the said request processing by the computer; and
executing the process of exchanging the legal currency deposited according to the said request processing into virtual currency by the said computer.

29. The intermediary method according to claim 25, further comprising:
receives a request to change the method of receipt from receipt in a virtual currency to receipt in a legal currency by the computer; and
when the change request is received, executing a process of exchanging the virtual currency remitted to the said account for legal currency by the computer.

30. The intermediary method according to claim 19, further comprising:
receives borrowing application information including the amount of the virtual currency loan and the borrowing period from a terminal used by a user, including said orderer or said order receiver by the computer; and
executing a process of mediating a virtual currency loan transaction between said user and said lender based on the borrowing application information received, by the computer.

31. The intermediary method according to claim 30, further comprising:
performing a process of collecting a fee from the interest payable by said user to said lender by said computer.

32. The intermediary method according to claim 19, further comprising:
executes a process of accepting an authentication request for a user including said orderer and said order receiver by the computer; and
judging whether or not to authenticate said user based on an evaluation stored in said distributed ledger, by the computer.

33. The intermediary method according to claim 19, wherein said distributed ledger is shared on a network constructed by a plurality of mutually communicative nodes.

34. An intermediary device that is communicatively connected to an orderer's terminal and an order receiver's terminal and that mediates transactions of goods or services between an orderer and an order receiver, comprising:
a transmitting part that transmits information on goods or services to an orderer's terminal;
a receiving part that accepts selection of goods or services through the said order receiver's terminal;
a settlement processing part that processes settlement for receiving and ordering selected goods or services;
a receiving part that receives the evaluation of the order receiver by the orderer who placed the said goods or services and the said order receiver's evaluation of the said orderer from both the said orderer's terminal and the said order receiver's terminal; and
a memory processing part that stores the received evaluations of the said orderer and the said order receiver in a distributed ledger.

35. A non-transitory computer readable recording medium storing a computer program comprising:
causing a computer to obtain information on goods or services to be ordered from an intermediary device that mediates transactions of goods or services between an orderer and an order receiver;
causing the computer to receive a selection of goods or services to be ordered from the said goods or services;
causing the computer to transmit information on the selected goods or services to the said intermediary device for ordering the selected goods or services;
causing the computer to receive an evaluation of an ordering party after ordering the said goods or services; and
causing the computer to transmit the said evaluation to be stored in a distributed ledger.

36. A non-transitory computer readable recording medium storing a computer program comprising:
causing a computer to receive information on the goods or services to be ordered selected by an orderer from an intermediary that mediates transactions of goods or services between an orderer and an order receiver;
causing the computer to receive an evaluation of the orderer, after receiving an order for the said goods or services; and
causing the computer to transmit the evaluation to store the evaluation in a distributed ledger.
